(19) United States
(12) Patent Application Publication
(10) Pub. No.: US 2012/0056416 A1
(43) Pub. Date: Mar. 8, 2012

(54) SYSTEMS AND METHODS FOR ESTABLISHING ELECTRICAL CONTINUITY ABOUT PIPES AND OTHER CONDUITS

(76) Inventor: VALERIE BRIAND, Caudebec-Les-Elbeuf (FR)

(21) Appl. No.: 13/223,341

(22) Filed: Sep. 1, 2011

Related U.S. Application Data
(60) Provisional application No. 61/379,951, filed on Sep. 3, 2010.

(51) Int. Cl. F16L 55/00; H01R 43/00

(52) U.S. Cl. 285/119; 137/15.01

(57) ABSTRACT

Systems and methods for establishing electrical continuity about pipes and other conduits are detailed. The systems may include conductive seals formed, for example, of polymeric and conductive materials. Polymeric materials may include rubber, silicon, and fluorosilicon and conductive materials may include metal charges, carbon, carbon nanotubes, carbon fibers, and intrinsically conducting polymers, although neither type of material is so limited.

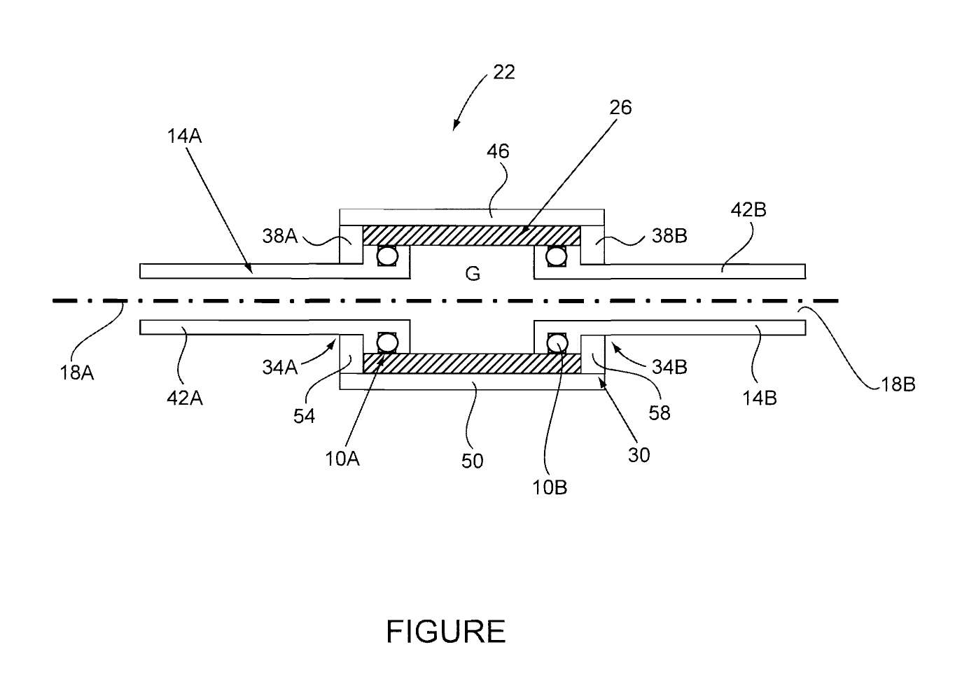

### REFERENCE TO PROVISIONAL APPLICATION

This application claims benefit of U.S. Provisional Application No. 61/379,951, filed Sep. 3, 2010, entitled “Method to Ensure Electrical Current Continuity and Electro Static Dissipation in Connection Between Conductive Fuel Piping Elements,” the contents of which are incorporated herein in their entirety by this reference.

### FIELD OF THE INVENTION

This invention relates to establishing electrical paths capable of dissipating electrostatic charges and more particularly, although not necessarily exclusively, to conductive seals for pipes intended to carry flammable fluids particularly in an aerospace environment.

### BACKGROUND OF THE INVENTION

Pipes, conduits, and the like (referred to herein as “pipes” or “piping”) may be used to convey fluids from one location to another. Fluid flow within the pipes may induce build-up of electrostatic charges especially near pipe walls because of friction mechanisms (and the dielectric constant of the flowing fluid). Arcing of the charges conceivably may occur via the fluid itself or through human contact with the piping. If the fluid is flammable, for example, such arcing could be dangerous, in that it might ignite the fluid. High-potential charges arcing through humans likewise could be problematic, as could arcing through objects sensitive to electrical current flow.

Accordingly, various means have been devised to convey electrical charges from pipes to electrical grounds. However, many of these means are not suitable for use at junctions or similar regions of piping. In particular, any such area needing to be sealed from an external environment presents charge-conveying difficulties, as conventional seals are often electrical insulators (or at best dielectrics) and thus lack sufficient conductivity to convey electrical charges satisfactorily.

As partial solution of this issue, external metallic conductors or circumferential metallic springs may be employed. Contact efficiency in these systems may vary, however, when (for example) pipe connections deflect and press more on some locations than on others. Corrosion of the metallic material also is problematic, and contact between the metallic material and the piping may not exist over the entire circumferences of the piping. Repairing these systems, furthermore, may require replacing many, if not all, of the components.

In other contexts, seals such as those of U.S. Pat. No. 4,556,591 to Bannick, Jr. may be used to provide electrical conductivity sufficient to “equalize[] static charges.” These planar seals may include both resin and carbon spheres and be used to adhere graphite-reinforced epoxy plates within fuel tanks of aircraft. However, there remains a need for development of conductive seals for fluid-conveying piping so as to dissipate associated electrical charges while complying with aeronautical rules, guidelines, specifications, and requirements..

### SUMMARY OF THE INVENTION

The present invention provides such means to dissipate electrical charges at junctions between fuel lines using conductive seals. Especially suitable for use in aeronautics, the present seals may be formed of polymeric materials, as are standard aeronautical seals. Suitable polymeric materials include, but are not limited to, rubber, silicon, fluorosilicon, and thermoplastics. Additionally forming the seals may be conductive materials such as metallic charges (from silver or other metals, for example), carbon, carbon fibers or nanotubes, or intrinsically conducting polymers. Preferably the conductive materials are added to the polymeric materials when the seals are formulated, although they conceivably could be applied or added later.

Although the present invention is well-suited for aeronautical applications, it may be employed in any situation in which dissipation of electrostatic charge is needed or where resistivity of a fuel line is less than 10⁹ ohms per meter under 500 volt tension. The fuel line itself may be made of essentially any material, including (but not limited to) rubber, thermoplastic materials, heat-hardening plastics or composites, or metals. However, because resistivity of the conductive seals of the present invention generally will be higher than resistivity of metallic fuel lines, some compensation in resistance may be necessary.

A presently-preferred coupling for a pair of conductive pipes includes two seals of the present invention, each adjacent the to-be-coupled end of its respective pipe. For cylindrical pipes, each annular seal circumscribes the pipe in contact with its exterior surface (or with an associated ferrule). Surrounding and contacting both seals may be a proof ring made of conductive material, with the proof ring being encapsulated in a (conductive) coupling ring. The proof ring supplies electrical continuity about exterior surfaces of the pair of pipes at their junction.

It thus is an optional, non-exclusive object of the present invention to provide methods of establishing electrical continuity about objects such as pipes.

It is also an optional, non-exclusive object of the present invention to provide conductive seals useful as part of systems for establishing electrical continuity about objects such as pipes.

It is another optional, non-exclusive object of the present invention to provide conductive seals for fuel- and other fluid-conveying pipes, especially such pipes employed in aeronautics fields.

It is a further optional, non-exclusive object of the present invention to provide conductive couplings including conductive seals.

Other objects, features, and advantages of the present invention will be apparent to those skilled in the relevant art with reference to the remaining text and the drawing of this application.

### BRIEF DESCRIPTION OF THE DRAWING

The FIGURE is a cross-sectional, partially-schematicized view of a coupling including conductive seals of the present invention.

### DETAILED DESCRIPTION

Illustrated in the FIGURE are exemplary seals 10A and 10B of the present invention. Also depicted are pipes 14A and 14B, which are shown as separate and distinct elements each defining a respective channel 18A or 18B through which fluid may flow. To ensure continuity of fluid flow through pipes 14A and 14B, they beneficially may be connected at a junction or joint. Element 22 illustrates an example of an assembly useful for connecting pipes 14A and 14B.

Element 22 may include seals 10A and 10B as well as either or both of proof ring 26 and coupling ring 30. If present, each of proof ring 26 and coupling ring 30 is preferably made of electrically-conductive material, although coupling ring 30 in particular need not necessarily conduct electricity. Such material may comprise one or more metals, composites, or thermoplastics, although any suitable material may be used. Hence, all of pipes 14A and 14B, proof ring 26, and coupling ring 30 beneficially are configured to conduct electricity.

This feature likewise is true for seals 10A and 10B. Electrically-conductive seals 10A and 10B may, if desired, be made of polymeric materials such as (but not limited to) rubber, silicon, or fluorosilicon together with conductive charges which may include (but again are not limited to) metals, carbon, carbon fibers, carbon nanotubes, or intrinsically conducting polymers. Preferably the conductive charges are both mixed with the polymeric materials during formation of the seals 10A-B and compatible with aeronautical standards, although in some instances such mixing or compatibility might not be necessary. As illustrated, seals 10A-B are annular in shape, matching the annular cross-sectional shape of respective pipes 14A-B. Seals 10A-B may have other shapes, however, if appropriate or desired.

Seals 10A and 10B, proof ring 26, and coupling ring 30 cooperate to allow element 22 to connect pipes 10A and 10B with both mechanical and electrical continuity. As shown in the FIGURE, seal 10A may be positioned at or near to-be-connected end 34A of pipe 14A. If ferrule 38A is present at end 34A, seal 10A may be placed in a cavity thereof. Otherwise, seal 10A may directly contact and circumscribe exterior surface 42A of pipe 14A. Similarly, seal 10B may be positioned at or near to-be-connected end 34B or pipe 14B, either within ferrule 38B or directly in contact with exterior surface 42B.

Depicted in the FIGURE is that proof ring 26 may then be positioned externally of ferrules 38A-B but preferably in direct contact with seals 10A-B. As depicted, proof ring 26 is cylindrical and sufficiently long to accommodate the widths of both ferrules 38A-B and any gap G desired between ends 34A-B when they are connected. Ferrules 38A-B, seals 10A-B, and proof ring 26 may be encapsulated in coupling ring 30 to complete element 22. As shown, coupling ring 30 may include cylindrical (or other) wall 46, first end plate 54, and second end plate 58, with wall 46 surrounding exterior surface 50 of proof ring 26. Annular plate 54, by contrast, surrounds exterior surface 42A of pipe 14A, whereas plate 58 similarly surrounds exterior surface 42B of pipe 14B. At least for purposes of electrical continuity, wall 46 preferably contacts exterior surface 50, and plates 54 and 58 preferably contact respective surfaces 42A and 42B.

Testing was performed for an exemplary assembly consistent with the FIGURE. For the testing, pipes 14A-B comprised two 500 mm long tubes made of conductive, fiberglass-reinforced epoxy resin. Each of ferrules 38A-B was made of conductive, fiberglass-reinforced polyetheretherketone (PEEK), and proof ring 26 and coupling ring 30 were made of aluminum. Each of seals 10A-B was made of fluorosilicon charged with carbon and had volumic resistivity less than six ohm-centimeters. Tests conducted on the assembly yielded resistance of only 3×10⁶ ohms.

The foregoing is provided for purposes of illustrating, explaining, and describing embodiments of the present invention. Modifications and adaptations to these embodiments will be apparent to those skilled in the art and may be made without departing from the scope or spirit of the invention. As a non-limiting example of such adaptations, either or both of pipes 14 A and 14B may instead by equipment (e.g. pumps, valves, etc.) or hardware (e.g. pass-walls, T- or Y-connectors, manifolds, etc.). Additionally, the contents of the Bannick, Jr. patent are incorporated herein in their entirety by this reference.

What is claimed is:

1. A pipe-connecting assembly comprising:
a. a first seal;
b. a proof ring configured to contact the first seal; and
c. a coupling ring configured to encapsulate at least the proof ring; and
in which each of the first seal and the proof ring conducts electricity.

2. An assembly according to claim 1 further comprising a second seal that conducts electricity.

3. An assembly according to claim 2 in which the first seal comprises polymeric material with added conductive material.

4. An assembly according to claim 3 in which the second seal comprises polymeric material with added conductive material.

5. An assembly for conveying fluid and having electrical and mechanical continuity, the assembly comprising:
a. a first fluid-accommodating member;
b. a second fluid-accommodating member;
c. a first ferrule associated with the first member and having a cavity;
d. a second ferrule associated with the second member and having a cavity;
e. a first seal positioned in the cavity of the first ferrule;
f. a second seal positioned in the cavity of the second ferrule;
g. a proof ring contacting the first and second seals; and
h. a coupling ring contacting the proof ring; and
in which each of the first and second members, the first and second seals, and the proof ring conducts electricity.

6. An assembly according to claim 5 in which at least one of the first and second members is selected from the group consisting of pipes, equipment, and hardware.

7. An assembly according to claim 5 in which the coupling ring encapsulates at least the proof ring.

8. An assembly according to claim 7 in which the first and second seals are annular and formulated of polymeric and conductive materials.

9. An assembly according to claim 8 in which the first and second members are pipes defining channels adapted to convey flammable fluid.

10. An assembly according to claim 9 for use on-board an aircraft.

11. A method of connecting first and second fluid-conveying, electrically-conductive pipes in a manner providing electrical and mechanical continuity through the connection, comprising:
a. contacting the first pipe with a connecting assembly comprising at least one electrically-conductive seal, an electrically-conductive proof ring contacting the at least one seal, and a coupling ring encapsulating the proof ring; and
b. contacting the second pipe with the connecting assembly.
